(19) United States
(12) Patent Application Publication
(10) Pub. No.: US 2009/0135981 A1
(43) Pub. Date: May 28, 2009

(54) Method for transforming element and producing energy

(75) Inventor: Norio Yabuuchi, Mie (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: High Scientific Research Laboratory, Mie (JP)

(21) Appl. No.: 12/292,863

(22) Filed: Nov. 26, 2008

(30) Foreign Application Priority Data
Nov. 27, 2007 (JP) 2007-305916

(51) Int. Cl. G21B 1/00

(52) U.S. Cl. 376/107

(57) ABSTRACT

To provide a reliable method for producing energy by means of nuclear condensation.

A method for transforming element comprises a deuterium nuclear is located on vertical angle of each surface composing regular hexahedron inside the metal crystal and an electron is located on the rest of vertical angle, wherein four deuterium nuclei are fused by Coulomb attraction between four protons and four electrons and transform to two helium atoms.

### FIELD OF THE INVENTION

The present invention relates to a method for transforming element by means of condensation fusion in a metal crystal which absorbed atomic deuterium nuclear and for producing energy by the fusion.

### BACKGROUND OF THE INVENTION

There have been known Patent Document 2 as a technique of absorbing hydrogen into ultra fine particle metal. Patent Documents 1, 3 and 4 given below disclose method for fusing atomic nuclear in the intrametal crystal which absorbed hydrogen. Patent Document 5 given below discloses a method for transforming nuclear from Cs to Pr and Sr to Mo, respectively.

### Patent Document 1: PCT Publication WO 2004/034406

### Patent Document 2: Patent No. 3720250

### Patent Document 3: Patent No. 3137548

### Patent Document 4: Japanese Patent Publication Laid-open No. 2004-85519

### Patent Document 5: Japanese Patent Publication Laid-open No. 2005-292150

The definite principle, however, relating to fusion of hydrogen atomic nuclear in the metal crystal have not yet been elucidated even in the above documents. Consequently, the possibility of nuclear condensation in crystal is not clear.

### SUMMARY OF THE INVENTION

An object of the present invention is to provide a method for transforming element by means of nuclear condensation and producing energy through its method by focusing attention on the event that condensation reaction of nuclear in solid is partially observed and by elucidating theoretical possibility.

The first aspect of the invention is a method for transforming element comprising:

locating deuterium nuclei on the respective vertical angles of each surface composing regular hexahedron in a metal crystal,

locating electrons on the rest of the respective vertical angles, wherein four deuterium nuclei are fused by coulomb attraction between four protons and four electrons and transform to two helium atoms.

The second aspect of the invention is a method for transforming element, wherein said metal crystal is crystal composed of hydrogen storage atom.

The third aspect of the invention is a method for transforming element, wherein said metal atom is palladium.

The fourth aspect of the invention is a method for transforming element, wherein said metal crystal is nano-scale crystalline particle.

The fifth aspect of the invention is a method of producing energy according, wherein energy which is liberated by said transforming element during deuterium nuclei fusion is used as output energy.

The present invention provides the logical possibility for fusion of 4 deuterium atomic nuclei. Atomic nuclei transformation of mass number 8 from Cs to Pr and Sr to Mo, respectively are observed, wherein Pd absorbed hydrogen.

According to the above aspect of the present invention, atomic nuclear transformation of mass number 8 is also possible. In case of the 4 deuterium being nuclear condensation, energy corresponding to the mass gap between the mass of 4 deuterium atoms and that of 2 helium atoms are produced by nuclear condensation.

### BRIEF DESCRIPTION OF THE DRAWINGS

FIG. 1 is a schematic diagram showing the location in which positively charged deuterium nuclei, i.e., deuterons, or D, and negatively charged electrons are alternatingly arranged at the vertices of a cube by the action of self-organization according to dissipation theory—that is to say, by form—so as to exist in the Platonic structure depicted.

FIG. 2 is a figure depicting ongoing condensation of two deuterons and one electron and depicting the process of ongoing condensation of two of four deuterons and one of four electrons toward the center.

### DESCRIPTION OF THE PREFERRED EMBODIMENTS

Nuclear-fusion reactions include deuterium-deuterium (DD) and deuterium-tritium (DT) reactions, with deuterium and tritium containing positively charged protons, and so between two positively charged deuterium atoms or between a deuterium and a tritium atom, the action of Coulomb repulsion makes fusion difficult. Accordingly, the author devised a combination in which Coulomb attraction is applied by employing electrons having negative charges of the same magnitude. This was found to result in action of Coulomb attraction 0.84 times greater than Coulomb repulsion, breaking through the Coulomb barrier and triggering a fusion reaction.

### 1. Elucidation Based on Pythagorean Principles

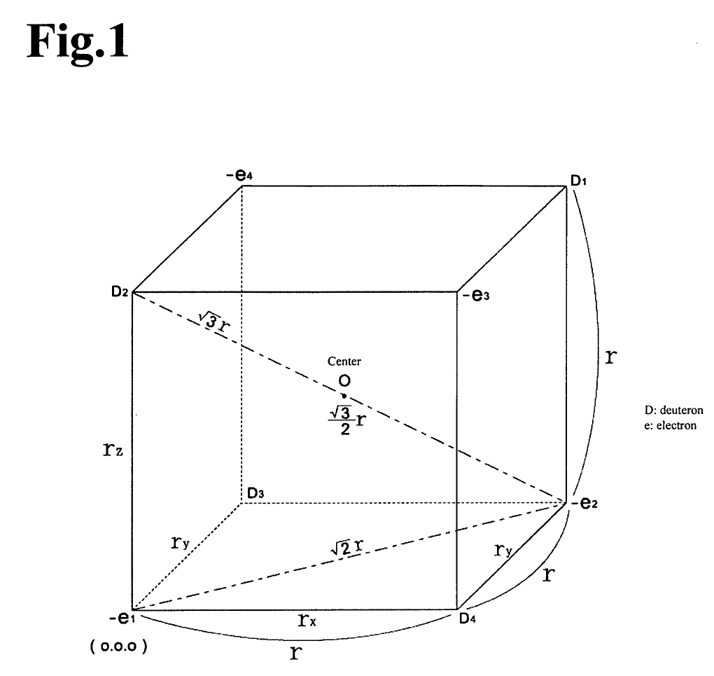

In FIG. 1, positively charged deuterium nuclei (hereinafter termed deuterons, or D) and negatively charged electrons are alternatingly arranged at the vertices of a cube by the action of self-organization according to dissipation theory—that is to say, by form—so as to exist in the Platonic structure depicted. FIG. 1 shows that deuterons and electrons are arranged at the vertices of a cube, a Platonic structure, and shows their relationship to the Pythagorean theorem

Based on the experimentation by Yoshiaki Arata that revealed that the four electrons and four deuterons invade the gap space between the elements of the lattice of a hydrogen-occlusion alloy, it is understood that, similarly to superconductivity, the four deuterons and the four electrons 300 to 600 times heavier that had become subnucleons in the solid crystal of the alloy formed a cube, which is a Platonic polyhedron, in the gap spaces between the lattices.

This formative action is a self-organizing force, mentioned in Greek philosophy and also subjected to consideration in the phase action mentioned by Heisenberg and von Weizsäcker of Germany. This self-organizing force is the capacity of mutual action between polymers discovered by Belgian Nobel laureate Ilya Prigogine five years ago. In the realm of the atom as well, Matthias Brack of Germany has reported that when minute metal fragments are sprayed into a vacuum, self-organizing force acts to bring about crystallization into Platonic structures. The distances between adjacent electrons and deuterons are all equal and form the 12 edges of a cube, and the distance of each is taken to be r.

r=1>0 (1.1)

Next, the distance between e1 and e2 is taken to be rₑ₁ₑ₂. Similarly, the distances between e1 and D4 and between e2 and D4 are respectively taken to be r_{e1D4} and r_{e2D4}. Because of the Pythagorean theorem, the ratio to unit length r in rₑ₁ₑ₂ is:

rₑ₁ₑ₂=\sqrt{2}r (1.2)

This holds true for all electrons at the vertices of regular polyhedra.

For the distance r_{e1D1} between e1 and D1, the Pythagorean theorem similarly reveals that the ratio to unit length r in r_{e1D2} is :

r_{e1D1}=\sqrt{3}r (1.3)

The ratio to unit length r in re1,O is:

r_{e1,O}=\sqrt{3}/2·r (1.4)

This holds for all relationships between deuterons and electrons existing at vertices in regular polyhedra.

### 2. Deuterons, Electrons, and Coulomb's Law

Coulomb's law is as follows:

F=q1q2/4Πεr² (2.1)

Here, q1 is a proton of positive charge 1, q2 is an electron of negative charge 1, ε is permittivity, and r is the distance between the charges. The Coulomb repulsion +F and attraction −F are proportional to the charge regardless of proton and electron mass, and are inversely proportional to the distance r.

As Arata's experiment has shown, four electrons and four deuterons appear to invade the spaces of the crystalline lattice of a solid hydrogen-occlusion alloy. In this case, as shown in FIG. 1, four electrons and deuterons each are taken to be arranged in mutual alternation to form a cube, a Platonic polyhedron, by the phase of the action of the self-organizing force. The balanced condensation force F of the Coulomb attraction and repulsion acting between the mutual electron and deuteron pairs is investigated. Taking the distance r between adjacent vertices of the cube is taken to be 1 yields this:

r=1 (2.2)

the total force F experienced by e1 is:

F=0.84Frxyz (2.3)

Based on this, the ratio of attraction and repulsion at e1 is revealed to be attraction 0.84 times greater than repulsion, thus accounting for the condensation toward the face center of the cube, and verifying that the same can be said for the values of e and D at the other vertices.

### 3. Distance and Other Factors at the Time of Collision Between an Electron and a Deuteron and Between Deuterons

Specifically, with respect to a collision between the electron and deuteron while moving from the vertices toward the face center O in the cube depicted in FIG. 1, according to (2.3) in section 2, the Coulomb condensation force acting upon the condensation is

F=0.84F (3.1)

Because of this, the electron and the deuteron both undergo Condensation as they move toward the face center O. This equation (3.1) represents the principle of condensation.

Further calculation is carried out through application of Ehrenfest's theorem. For the momentum of classical mechanics and the momentum quantum mechanics, if a wave packet is considered to be a large particle, even classical mechanics holds true within its range. As an example, momentum in classical mechanics is P=dx/dt and in quantum mechanics is P=d<x>/dt. That is to say, within the wave packet the uncertainty principle applies, and the location of the electron within the wave packet cannot be determined with certainty, although it is certain to exist within the wave packet. Moreover, it is also understood that the probability is highest at the center of the wave packet. Because of this, the orbit linking one wave packet to another can be ascertained. Further, when the wave packet is subject to being bound by a circumferential orbit due to centrifugal force and Coulomb attraction, so that the orbit is ascertained, the collision orbits of wave packets subject to binding by condensation force due Coulomb attraction and repulsion can be ascertained as well. Even in the section on elastic collisions in the ninth chapter of the work on quantum mechanics by Lev Landau and Evgeny Lifshitz, when scattering by the atomic nuclei and electrons is computed through application of quantum mechanics that includes wave motion, the results are exactly the same as the values for the Ernest Rutherford's scattering of the classical theory that does not posit wave motion.

Accordingly, the assumed requirements for development of the theory are the following requirements with regard to the deuterons:

Deuteron diameter:

r_{D}=4.31fm (3.2)

Deuteron velocity:

V_{D0}=d<x>/dt=⅛C (3.3)

With respect to the motion of deuterons that invade the spaces within the lattice, the alpha-particle velocity is 1/16 the speed of light C, and so deuteron mass is taken to be half of that, making ⅛ of C required. Because of this, Arata conjectured that, due to the temperature and pressure applied to the lattice, the deuterons absorbed velocity energy of ⅛ C due to the oscillation energy of the lattice and the mutual Coulomb attraction of the electrons, producing fusion. The assumed requirements with regard to the electrons are given below. These are not bound electrons of the lattice, but rather conduction electrons existing in the vacuum spaces in the lattice. In this case, as during superconductivity, electrons within the metal of the palladium alloy were required to have 300 to 1,000 times the mass or ordinary electrons.

The phenomenon of superconductivity is taken to occur in metal alloys. What plays a critical role in this is electrons that are 300 to 1,000 times heavier than ordinary electrons. Occurrence of solid nuclear fusions requires the same alloys. As Arata's experiments also made clear, it is taken to be evident that fusion in a solid composed of an alloy of metallic palladium can occur efficiently. Based on this matter, the existence of heavy electrons reduced to subnucleons is conjectured to be an essential requirement in fusion in solids as well. That is to say, for electron mass,

mₑ=300mₑ₀ to 1.000mₑ₀ (3.4)

mₑ₀=911×10⁻³¹ [kg], (3.5)

and so electron velocity is pulled by the deuteron charge; this velocity is a necessary condition, and so it yields this:

d<x>/dt=Ve=⅛·C (3.6)

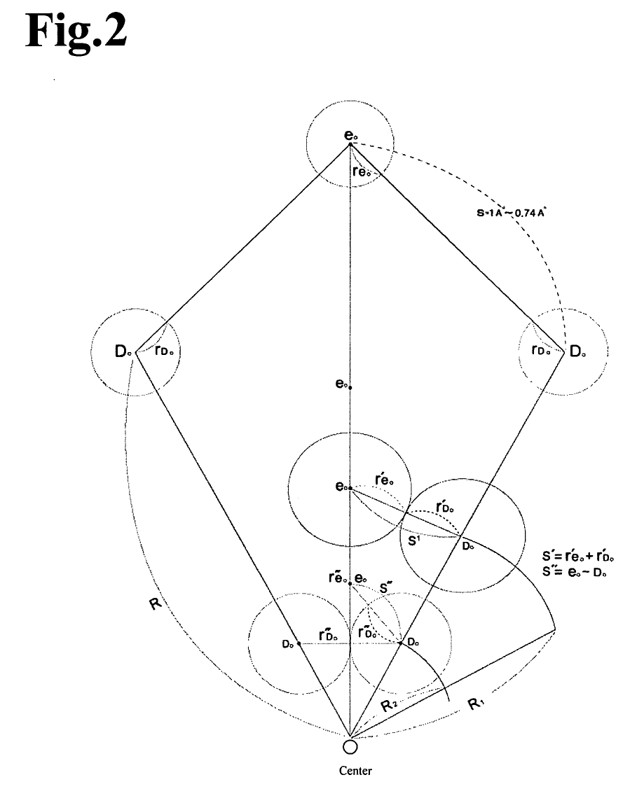

The center, the electron, and the deuteron at the time of collision, based on FIG. 2, are:

R1=31.8 [fm] (3.7)

FIG. 2 is shows a figure depicting ongoing condensation of two deuterons and one electron and depicting the process of ongoing condensation of two of four deuterons and one of four electrons toward the center. After collision, the electron, according to the theory of observation, is in a state equivalent to that of having been observed at the site of collision by the large deuteron, and it is stripped of its wave packet and shrinks to a naked electron. This naked electron and the deuteron condense toward the face center O. The naked electron then shrinks, and because of its small size, it cannot prevent fusion due to collision between deuterons.

According to the theory of observation, the electron has the breadth of the wave packet of de Broglie's wavelength, but when it collides with a deuteron and shrinks to a point at the time of the observed state of the location of the electron, the radius becomes r=2.50×10⁻¹⁶ [m]. This yields the condition in which the electron wave packet does not impede mutual collision between deuterons.

The electron enters the state in which it is observed because of the deuterons and the diameter shrunken electron is taken to be this:

rₑ₀″=2.50×10⁻¹⁶ [m] (3.8)

Further, the distance between the two deuterons at re₀ is calculated to be:

rs″=1/\sqrt{2}·r″=6.11×10⁻¹⁵ [m] (3.9)

This is the distance rs″ between the mutual deuterons and electrons at the time of mutual collision between deuterons. Next, distance R2 from the deuteron to the center O,

R₂=5.29 [fm]. (3.10)

This is the distance between the deuteron and the face center at the time of collision between mutual deuterons.
4. Coulomb Potential at the Bohr Radii of Electrons that are 300 Times Heavier and Deuterons

With regard to the Coulomb potential energy at the Bohr radii of the 300-times-heavier subnucleon electron and deuteron, within the alloy, as with electrons involved in superconductivity, the phenomenon of electrons 300 to 1,000 times heavier normal electrons occurs, and so in this case as well, occurrence of a similar heavy-electron phenomenon is required. Assuming the Coulomb potential Ue″ when the distance r between the electron and the deuteron is equal to B″ yield this:

Ue″=1.46·e²/4ΠεB″=1.11×10⁴ [eV] (4.1)

### 5. Coulomb Attraction and Movement Energy at the Time of Collision Between Deuterons D

Regarding the mutual distance rs″ between the deuterons at the time of mutual collision between deuterons, equation (3.9) of section 3 yields rs″=6.11×10⁻¹⁵ [m] and the distance between mutual deuterons is 8.62×10⁻¹⁵ [m].

The Coulomb attraction applied to the electrons at this time of collision between deuterons is:

|F″|=0.84 ·e²/4πΠεr²s″=32.4×10¹⁸ [eV/m] (5.1)

Therefore, the Coulomb energy due to condensing force between mutual electrons or deuterons causes mutual collision between deuterons by means of the immense force of 32.4 exa, breaking the nuclear barrier and exerting force for up to the 2.5 [fm] radius of the deuteron, and thereafter causing fusion by nuclear force. The movement energy in the case of mutual collision between deuterons in this event is similarly calculated as follows:

E_{D}=1.50×10⁷ [eV] (5.2)

which is sufficient collision movement energy for nuclear fusion.

### 6. Movement Energy of Electrons Passing the Bohr Radius of a Heavy Electron

First, when electron mass was 300 times greater, then according to the formula, the Bohr radius was initially

B=4peh²n²/mₑ·e². (6.1)

The scale factor for the heavy electrons was converted based on M_{e″}=300 mₑ.

Next, we determine the movement energy of the electrons at the position of the Bohr radius at the time of movement toward the face centers from the locations of the cluster of vertices of the initial cube. When the energy that the electron obtains by Coulomb attraction is taken to be ΔWₑ₁, The formula for work is

$$Δ {W}_{e 1} = - {\int }_{r 1}^{r 2} F d r , \qquad ( 6.2 )$$

and because F=0.84·e²/4Πεr²,

For r², based on the Bohr radius, the distance from the center to the Bohr radius is r²=1.52×10⁻¹³ and for r¹, the distance to the center before condensation is 0.64×10⁻¹⁰, and so:

$$Δ {W}_{e 1} = - {\int }_{0.64 \times {10}^{- 10}}^{1.52 \times {10}^{- 13}} ( 0.84 \cdot {e}^{2} / 4 π ɛ ) {r}^{- 2} d r \\ = 7.94 \times {10}^{3} [ eV ] \qquad ( 6.3 )$$

For the movement energy of an electron at a vertex on the initial cube, mass was 300 times larger, and velocity was d<x>/dt=⅛C, and so when the movement energy of the electron before condensation is taken to be Eₑ₁, the following is yielded:

Eₑ₁=½300 mₑ₁ (⅛C)²·=1.92·10⁻¹³ [J] (6.4)

When movement energy at close to the Bohr radius B″ is taken to be E″ₑ₁, equations (6.3) and (6.4) yield this:

E″ₑ₁=Eₑ₁+ΔWₑ₁=1.21×10⁶ [eV] (6.5)

Therefore, by means of this energy of 0.74 Å, the electron breaks through the normal state at the Bohr radius and condensing force is exerted by the electron.

In the same way, calculation with an electron mass of 600 times greater at the location of B″ yield this:

* Eₑ₁=2.41×10⁶ [eV] (6.6)

Therefore, according to (6.5) and (6.6), by means of this energy of 1.21˜2.41×10⁶ eV, the electron breaks through the normal state at the Bohr radius and condensing force is exerted by the electron.

### CONCLUSION

The previous sections have described how the Coulomb barrier is breached and condensation and nuclear fusion occur through a combination of Coulomb attraction and repulsion for four deuterons and four heavy electrons at the vertices of a Platonic structure, in which the deuterons receive movement energy of E_{D}=1.50×10⁷ [eV]. That is to say, as can be seen from FIG. 1, first the two deuterons at D₁ and D₂ above the core and the two deuterons at D₃ and D₄ below the core respectively undergo fusion, producing two helium nuclei. The two helium nuclei then fuse to produce a single compound helium nucleus. The beryllium then breaks down to again form two helium nuclei. This phenomenon is the equivalent of the activation-energy phenomenon that occurs in a molecular reaction. The equation expressing it is

²D+²D+²D+²D +→⁴H*ₑ₂+⁴H*ₑ₂→⁸Be*₄→⁴Hₑ₂+⁴Hₑ₂+47.6 MeV, (where “*” indicates compound nuclei), (7.1)

which yields 47.6 MeV, an enormous amount of energy.

The mechanics of nuclear fusion are explained in this way by means of Platonic structures. The use of Platonic structures to describe molecular structure in college chemistry textbooks is now commonplace, with fullerenes being the most well-known examples of modified Platonic structures. In the field of celestial dynamics as well, the physical cosmology of Platonic solids announced by Dr. Jeffrey Weeks in 2004 is in the process of being proven. Accordingly, the structures of elementary particles, atomic nuclei, molecules, and celestial mechanics are fundamentally Platonic solids, and as Euler's formula of V+F−E=2 for regular polyhedra suggests, the number 2 is the invariable quantity for the world's structure. In particular, V corresponds to point-mass number, F to field, and E to nuclear force, electromagnetic force, and gravity.

What is claimed is:

1. A method for transforming element comprising:
locating deuterium nuclei on the respective vertical angles of each surface composing regular hexahedron in a metal crystal,
locating electrons on the rest of the respective vertical angles, wherein four deuterium nuclei are fused by coulomb attraction between four protons and four electrons and transform to two helium atoms.

2. A method for transforming element according to claim 1, wherein said metal crystal is crystal composed of hydrogen storage atom.

3. A method for transforming element according to claim 2, wherein said metal atom is palladium.

4. A method for transforming element according to claim 1, wherein said metal crystal is nano-scale crystalline particle.

5. A method for transforming element according to claim 2, wherein said metal crystal is nano-scale crystalline particle.

6. A method for transforming element according to claim 3, wherein said metal crystal is nano-scale crystalline particle.

7. A method of producing energy according to claim 1, wherein energy which is liberated by said transforming element during deuterium nuclei fusion is used as output energy.

8. A method of producing energy according to claim 2, wherein energy which is liberated by said transforming element during deuterium nuclei fusion is used as output energy.

9. A method of producing energy according to claim 3, wherein energy which is liberated by said transforming element during deuterium nuclei fusion is used as output energy.

10. A method of producing energy according to claim 4, wherein energy which is liberated by said transforming element during deuterium nuclei fusion is used as output energy.
